(19) United States
(12) Patent Application Publication
(10) Pub. No.: US 2011/0018979 A1
(43) Pub. Date: Jan. 27, 2011

(54) DISPLAY CONTROLLER, DISPLAY CONTROL METHOD, PROGRAM, OUTPUT DEVICE, AND TRANSMITTER

(75) Inventors: Masashi Ota, Tokyo (JP); Noboru Murabayashi, Saitama (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Sony Corporation, Tokyo (JP)

(21) Appl. No.: 12/894,486

(22) Filed: Sep. 30, 2010

(30) Foreign Application Priority Data
Jun. 11, 2009 (JP) 2009-254957

(51) Int. Cl. H04N 13/04

(52) U.S. Cl. 348/51; 348/42; 348/E13.075

(57) ABSTRACT

A display controller includes: an extraction means for extracting a characteristic of at least one of image data and sound data of content; a detection means for detecting a predetermined section of the content for which an evaluation value calculated on the basis of the characteristic extracted by the extraction means is equal to or larger than a threshold value; and a display control means for controlling display of a representative image of each scene of the content, the display control means displaying a representative image of a scene of the predetermined section so as to be recognized as a three-dimensional image and displaying a representative image of a scene outside the predetermined section so as to be recognized as a two-dimensional image.

### BACKGROUND OF THE INVENTION

1. Field of the Invention

The present invention relates to a display controller, a display control method, a program, an output device, and a transmitter and in particular, to a display controller, a display control method, a program, an output device, and a transmitter which make it possible to watch 3D content effectively while alleviating a feeling of fatigue.

2. Description of the Related Art

In recent years, a 3D (three-dimensional) display method which makes it possible for a viewer to recognize an image stereoscopically has been drawing attention as a display method of an image which became realizable with an improvement in the number of pixels of a display device, such as an LCD (Liquid Crystal Display), or an improvement in the frame rate.

Hereinafter, an image through which a viewer can recognize a subject stereoscopically when seeing it is called a 3D image and content including the data of a 3D image is called 3D content. In addition, reproduction for displaying a 3D image is called 3D reproduction. Reproduction for displaying a normal 2D image (planar image through which it is not possible to recognize a subject stereoscopically) is called 2D reproduction.

Methods of enjoying a 3D image include a glasses method, which uses polarized filter glasses or shutter glasses, and a naked-eye method which does not use glasses, such as a lenticular method. In addition, reproduction methods of displaying a 3D image include a frame sequential method which alternately displays an image for a left eye (L image) and an image for a right eye (R image) with parallax. By sending the image for a left eye and the image for a right eye to the left and right eyes of a viewer, respectively, through shutter glasses or the like, it becomes possible to make the viewer feel a three-dimensional effect.

As realistic expression becomes possible, techniques for such 3D reproduction are being actively developed. Moreover, a technique of displaying a 3D image by generating 3D content on the basis of content (2D content) used for normal 2D reproduction is also under development. There is a technique using parallax of images as a method of generating 3D content from 2D content (for example, JP-A-7-222203).

A 3D image and a 2D image have different image characteristics. Accordingly, if a user watches 3D images for a long time, the user may be more fatigued than when the user watches 2D images. Since the user feels that the 3D image is more realistic than the normal 2D image, there is a possibility that the user will watch the content for a long time without consciously meaning to.

As a result, a feeling of fatigue may increase before the user notices it, compared with the case of watching normal 2D images. For this reason, various techniques of alleviating the feeling of fatigue when watching 3D images have been proposed (for example, JP-A-2006-208407).

### SUMMARY OF THE INVENTION

Among recording apparatuses which record normal 2D content, such as a hard disk recorder commercially available in recent years, there is a recording apparatus in which a mode for reproducing only a specific scene is prepared as a reproduction mode of recorded content.

For example, when the content to be reproduced is a television program, it is possible to watch especially interesting parts of the whole program effectively by reproducing only the climax scene of the program. Detection of the climax scene is automatically performed by a recording apparatus by analyzing the image data and the sound data of the program.

Performing such special reproduction for 3D content may also be considered. Since a 3D image can be expressed more realistically than a 2D image, it is possible to show a noted scene, such as a climax scene, more effectively.

For example, when 3D content to be reproduced is content of a sports program, such as soccer, it may be considered to express a scene related to scoring or a scene related to winning or losing realistically so that the user can watch the program more effectively. In the case of using normal 2D content, it is difficult to perform such an expression for more effective watching.

In view of the above, it is desirable to make it possible to watch 3D content effectively while alleviating a feeling of fatigue.

According to a first embodiment of the present invention, there is provided a display controller including: an extraction means for extracting a characteristic of at least one of image data and sound data of the content; a detection means for detecting a predetermined section of the content for which an evaluation value calculated on the basis of the characteristic extracted by the extraction means is equal to or larger than a threshold value; and a display control means for controlling display of a representative image of each scene of the content, the display control means displaying a representative image of a scene of the predetermined section so as to be recognized as a three-dimensional image and displaying a representative image of a scene outside the predetermined section so as to be recognized as a two-dimensional image.

It may be possible to further provide a conversion means for converting the input content into content including image data for a left eye and image data for a right eye with parallax for displaying a three-dimensional image when the content input as an object to be reproduced is content including only image data for displaying a two-dimensional image as image data. In this case, the display control means may display a representative image of a scene of the predetermined section on the basis of the content converted by the conversion means and may display a representative image of a scene outside the predetermined section on the basis of the input content.

When the content input as an object to be reproduced is content including image data for a left eye and image data for a right eye with parallax as image data, the display control means may display a representative image of a scene of the predetermined section on the basis of the image data for a left eye and the image data for a right eye included in the input content and may display a representative image of a scene outside the predetermined section on the basis of either the image data for a left eye or the image data for a right eye.

According to the first embodiment of the present invention, there is also provided a display control method including the steps of: extracting a characteristic of at least one of image data and sound data of the content; detecting a predetermined section of the content for which an evaluation value calculated on the basis of the extracted characteristic is equal to or larger than a threshold value; and displaying a representative image of a scene of the predetermined section so as to be recognized as a three-dimensional image and displaying a representative image of a scene outside the predetermined section so as to be recognized as a two-dimensional image when displaying a representative image of each scene of the content.

According to the first embodiment of the present invention, there is also provided a program causing a computer to execute processing including the steps of: extracting a characteristic of at least one of image data and sound data of the content; detecting a predetermined section of the content for which an evaluation value calculated on the basis of the extracted characteristic is equal to or larger than a threshold value; and displaying a representative image of a scene of the predetermined section so as to be recognized as a three-dimensional image and displaying a representative image of a scene outside the predetermined section so as to be recognized as a two-dimensional image when displaying a representative image of each scene of the content.

According to a second embodiment of the present invention, there is provided an output device including: an extraction means for extracting a characteristic of at least one of image data and sound data of the content; a detection means for detecting a predetermined section of the content for which an evaluation value calculated on the basis of the characteristic extracted by the extraction means is equal to or larger than a threshold value; and an output means for outputting a representative image of each scene of the content, the output means outputting a representative image of a scene of the predetermined section as a three-dimensional image and outputting a representative image of a scene outside the predetermined section as a two-dimensional image.

According to a third embodiment of the present invention, there is provided a transmitter including: an extraction means for extracting a characteristic of at least one of image data and sound data of the content; a detection means for detecting a predetermined section of the content for which an evaluation value calculated on the basis of the characteristic extracted by the extraction means is equal to or larger than a threshold value; and a transmission means for transmitting data regarding the detected predetermined section together with the image data of the content.

According to a fourth embodiment of the present invention, there is provided a display controller including: a receiving means for receiving data of the content including at least image data and also receiving data regarding a predetermined section of the content for which an evaluation value calculated on the basis of a characteristic of at least one of image data and sound data of the content is equal to or larger than a threshold value; and a display control means for controlling display of a representative image of each scene of the content, the display control means displaying a representative image of a scene of the predetermined section so as to be recognized as a three-dimensional image and displaying a representative image of a scene outside the predetermined section so as to be recognized as a two-dimensional image.

According to the first embodiment of the present invention, a characteristic of at least one of the image data and the sound data of the content is extracted and a predetermined section of the content, for which the evaluation value calculated on the basis of the extracted characteristic is equal to or larger than the threshold value, is detected. When displaying a representative image of each scene of the content, a representative image of a scene of the predetermined section is displayed so as to be recognizable as a three-dimensional image and a representative image of a scene outside the predetermined section is displayed so as to be recognizable as a two-dimensional image.

According to the second embodiment of the present invention, a characteristic of at least one of the image data and the sound data of the content is extracted and a predetermined section of the content, for which the evaluation value calculated on the basis of the extracted characteristic is equal to or larger than the threshold value, is detected. Moreover, when displaying a representative image of each scene of the content, a representative image of a scene of the predetermined section is output as a three-dimensional image and a representative image of a scene outside the predetermined section is output as a two-dimensional image.

According to the third embodiment of the present invention, a characteristic of at least one of the image data and the sound data of the content is extracted and a predetermined section of the content, for which the evaluation value calculated on the basis of the extracted characteristic is equal to or larger than the threshold value, is detected. Moreover, the data regarding the detected predetermined section is transmitted together with the image data of the content.

According to the fourth embodiment of the present invention, the data of the content including at least the image data is received and the data regarding the predetermined section of the content, for which the evaluation value calculated on the basis of a characteristic of at least one of the image data and the sound data of the content is equal to or larger than the threshold value, is also received. When controlling display of a representative image of each scene of the content, a representative image of a scene of the predetermined section is displayed so as to be recognized as a three-dimensional image and a representative image of a scene outside the predetermined section is displayed so as to be recognized as a two-dimensional image.

According to the embodiments of the present invention, it is made possible to watch 3D content effectively while alleviating a feeling of fatigue.

### BRIEF DESCRIPTION OF THE DRAWINGS

FIG. 1 is a view showing an example of the configuration of a 3D image display system according to an embodiment of the present invention;

FIG. 2 is a view showing an example of a change of the climax evaluation value of each scene and display of an image;

FIG. 3 is a view showing an example of display of a display device;

FIGS. 4A and 4B are views showing other examples of display of the display device;

FIG. 5 is a block diagram showing an example of the configuration of a display controller;

FIGS. 6A and 6B are views showing a portion with parallax in a frame;

FIGS. 7A and 7B are other views showing a portion with parallax in a frame;

FIGS. 8A and 8B are other views showing a portion with parallax in a frame;

FIGS. 9A and 9B are views showing a state of shutter glasses;

FIG. 10 is a block diagram showing an example of the configuration of a content control section;

FIG. 11 is a block diagram showing another example of the configuration of the content control section;

FIG. 12 is a block diagram showing an example of the configuration of a system controller;

FIG. 13 is a flow chart for explaining processing of a display controller;

FIG. 14 is a block diagram showing an example of the configuration of a content control section;

FIG. 15 is a view showing an example of the configuration of a 3D image display system according to another embodiment of the present invention; and

FIG. 16 is a block diagram showing an example of the configuration of hardware of a computer.

### DESCRIPTION OF THE PREFERRED EMBODIMENTS

### 3D Image Display System

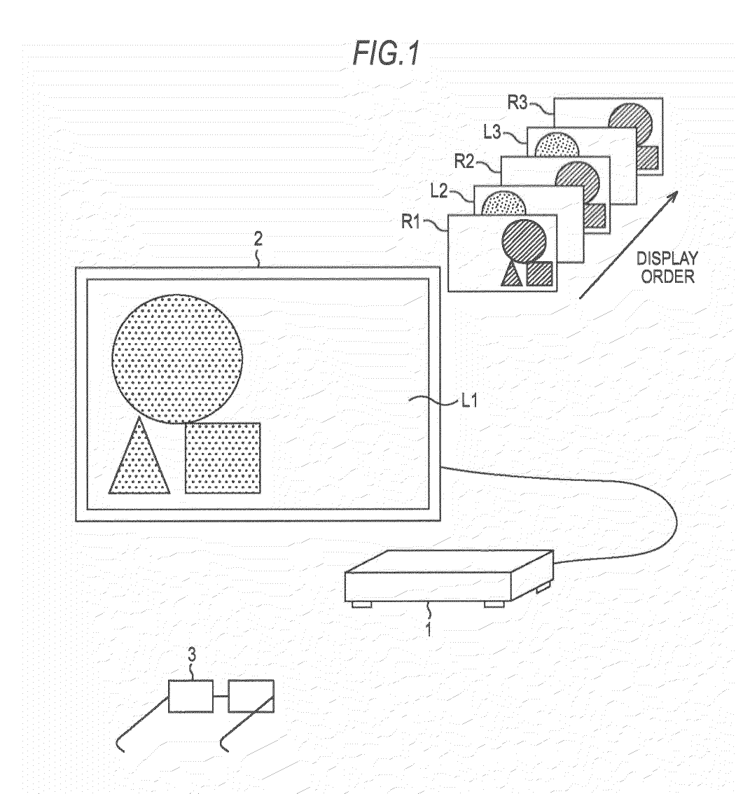

FIG. 1 is a view showing an example of the configuration of a 3D image display system according to one embodiment of the present invention.

As shown in FIG. 1, the 3D image display system includes a display controller 1, a TV 2, and shutter glasses 3. That is, a watching method of a 3D image based on the 3D image display system in FIG. 1 is a method using glasses. A user who is a content viewer wears the shutter glasses 3.

The display controller 1 reproduces the content and displays an image (moving image) of the content on the TV (television receiver) 2. For example, the display controller 1 reproduces the content recorded on a built-in HDD or the content recorded on a Blu-ray (trademark) disc inserted in a drive. The content to be reproduced by the display controller 1 is content, such as a television program or a film, and includes image data and sound data.

Here, the case will be described in which the image data included in the content to be reproduced is data for displaying a normal 2D image with no parallax when two frames, which continue in display order, are compared.

The display controller 1 displays an image of the content on the TV 2 as a 2D image and also outputs the sound of the content from a speaker (not shown). The display controller 1 and the TV 2 are connected to each other, for example, by a cable that meets the HDMI (High Definition Multimedia Interface) specifications.

Moreover, the display controller 1 analyzes the image data and the sound data of the content to detect an important section of the content. For example, a climax section of the content which is a television program is detected as the important section. Detection of the important section will be described later.

When the current reproduction position becomes a position of an important section during reproduction of the content, the display controller 1 generates the data of a 3D image by converting the data of a 2D image included in the content to be reproduced and displays an image of the content as a 3D image.

In FIG. 1, an image L1 for a left eye is displayed on the TV 2. Subsequently, as shown in the upper right portion in FIG. 1, an image for a left eye and an image for a right eye, such as an image R1 for a right eye, an image L2 for a left eye, an image R2 for a right eye, an image L3 for a left eye, an image R3 for a right eye, . . . , are alternately displayed.

A control signal including the information on a vertical synchronization signal of an image is supplied from the display controller 1 to the shutter glasses 3 through wireless communication using an infrared ray, for example. A light transmissive section on the left eye side and a light transmissive section on the right eye side of the shutter glasses 3 are formed by a liquid crystal device capable of controlling its polarization characteristic.

The shutter glasses 3 repeat two shutter open and close operations of “left eye open and right eye close” and “left eye close and right eye open” alternately according to a control signal. As a result, only an image for a right eye is input to the right eye of the user and only an image for a left eye is input to the left eye. By viewing the image for a left eye and the image for a right eye alternately, the user feels an image of the important section of the content as an image with a three-dimensional effect.

When the current reproduction position becomes a position outside the important section, the display controller 1 ends the display as a 3D image and displays an image of the content as a 2D image. In addition, the display controller 1 controls the shutter glasses 3 so that the characteristics of the light transmissive section on the left eye side and the light transmissive section on the right eye side become the same characteristics.

By displaying only an image of an important section of the entire content as a 3D image as described above, it becomes possible to alleviate a feeling of fatigue of the user compared with the case where the user watches images of the entire content as 3D images.

In addition, since an important section can be emphasized by displaying an image of the important section of the content as a 3D image for the user, the user can watch the content effectively.

### Display Example

A part of the TV 2 may be displayed in a 3D display method instead of switching a display method of the entire TV 2 between a 2D display method and a 3D display method.

The case will be described in which a representative image of a scene of an important section is displayed as a 3D image and a representative image of a scene outside the important section is displayed as a 2D image when representative images of respective scenes of the content are displayed side by side (thumbnail display).

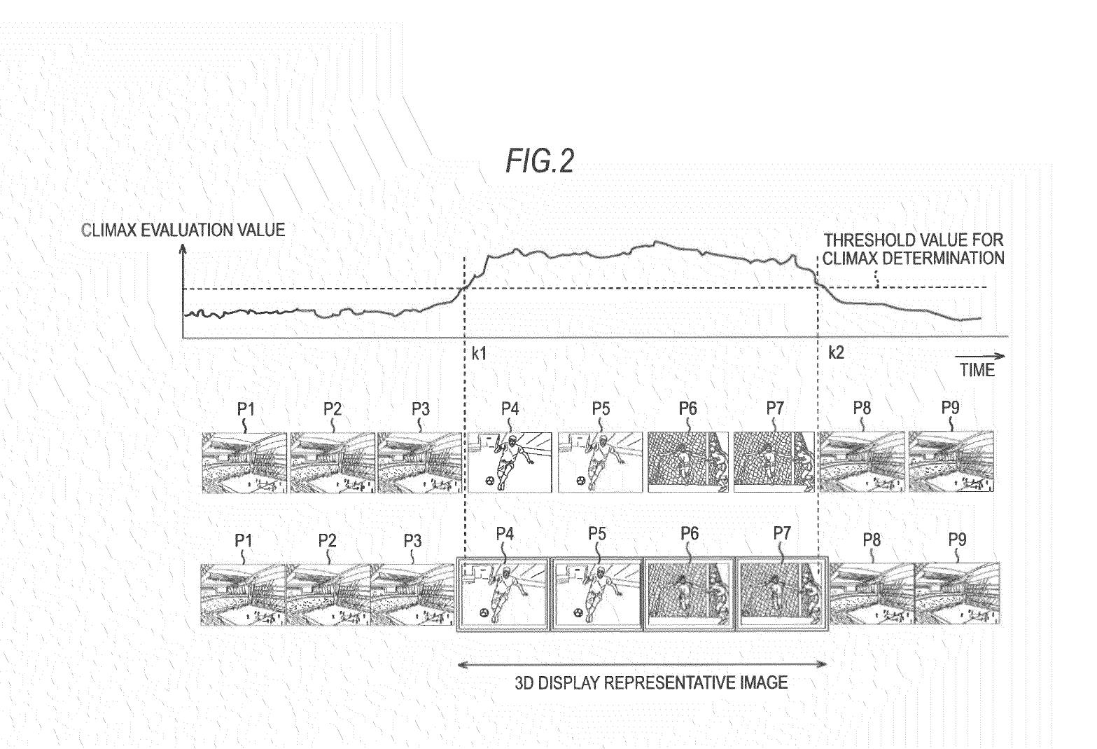

FIG. 2 is a view showing an example of a change of the climax evaluation value of each scene and display of an image.

In the example shown in FIG. 2, the content to be reproduced is a soccer broadcast. For example, the soccer broadcast is recorded and is stored on the HDD in the display controller 1. The image data and the sound data of the soccer broadcast are analyzed (characteristics thereof are extracted) at a predetermined timing, for example, before reproduction starts or during reproduction.

The characteristics of the image data are degrees of zoom and pan, for example. The degrees of zoom and pan are detected by comparing the pixel values of frames, for example. The characteristics of the sound data are sound volume, for example.

The display controller 1 calculates, as a climax evaluation value, a value obtained by adding a value, which is obtained by quantifying the characteristics extracted from image data, and a value obtained by quantifying the characteristics extracted from the sound data, for example. A waveform shown in the upper portion in FIG. 2 indicates a change of the climax evaluation value according to unit time of the soccer broadcast when the horizontal axis is a time and the vertical axis is a climax evaluation value. In addition, the climax evaluation value may be calculated from either the characteristics extracted from the image data or the characteristics extracted from the sound data.

The display controller 1 compares the climax evaluation value of each time with a threshold value and detects a section, in which the climax evaluation value equal to or larger than the threshold value is detected for a predetermined time or more, as a climax section, that is, an important section. In the example shown in FIG. 2, a section from time k1 to time k2 is detected as an important section. Detection of an important section in the case of switching the display method of the entire TV 2 between a 2D display method and a 3D display method, which was described with reference to FIG. 1, is also performed in this way.

Images P1 to P9 shown in the middle of FIG. 2 are representative images of respective scenes. In the display controller 1, detection of scene change is also performed. For example, one frame at the position immediately after a detected scene change is selected as a representative frame. In addition, a representative image which is a still image is generated by reducing the selected representative frame. A moving image formed by still images, which are obtained by reducing a plurality of frames including the representative frame, may be used as a representative image.

In the example shown in FIG. 2, among the images P1 to P9, the images P4 to P7 are representative images of scenes of the important section and the images P1 to P3, P8, and P9 are representative images of scenes outside the important section.

When displaying a plurality of representative images on the TV 2 side by side, the images P4 to P7 are displayed as 3D images and the other images P1 to P3, P8, and P9 are displayed as 2D images. Showing the images P4 to P7, among images shown in the lower portion in FIG. 2, using frames surrounding them indicates that the images P4 to P7 are displayed as 3D images.

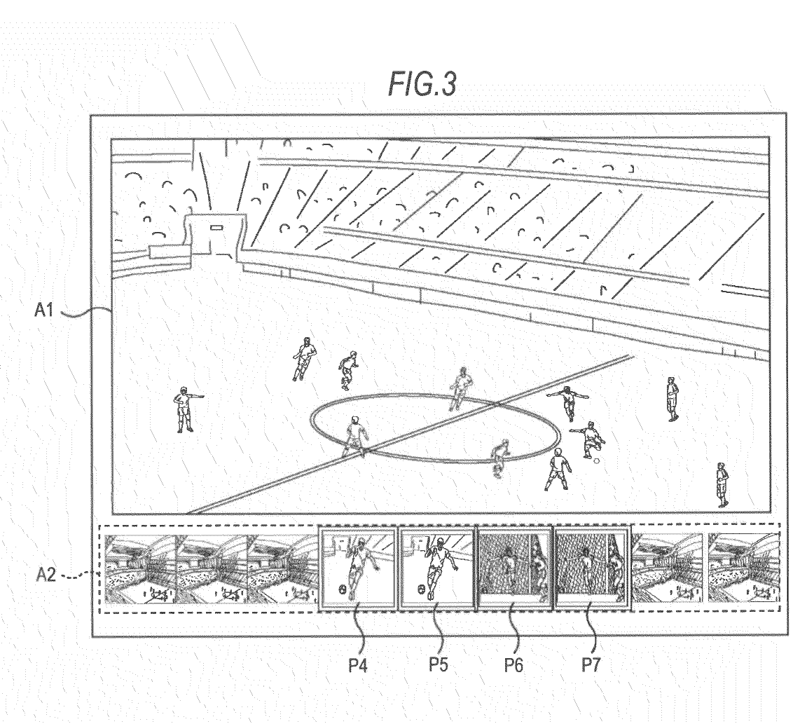

FIG. 3 is a view showing an example of display of the TV 2.

For example, when displaying a representative image of each scene is instructed during reproduction of a soccer broadcast, a screen of the TV 2 which has displayed images of the program as 2D images on the whole screen until then is changed to a screen shown in FIG. 3. In the example shown in FIG. 3, a main screen area A1 and a time-series representative image area A2 are formed on the screen of the TV 2.

The main screen area A1 is an area where an image of the soccer broadcast during reproduction is displayed as a 2D image. The time-series representative image area A2 is an area where representative images are displayed in a time-series manner. As shown in a state surrounded by frames in FIG. 3, the images P4 to P7 among representative images displayed in the time-series representative image area A2 are displayed as 3D images. For example, the user can start the reproduction after a scene starting from the selected representative image by operating a remote controller (not shown) to select a predetermined representative image.

Thus, by displaying only a representative image of a scene of an important section as a 3D image, the user can check the content of the scene of the important section more effectively compared with the case where all representative images are displayed as 2D images.

In addition, an image of a program displayed on the main screen area A1 may also be displayed as a 3D image. In this case, the data of the 2D images of the soccer broadcast is converted into data of a 3D image, and display of the main screen area A1 is performed using the image data obtained by conversion.

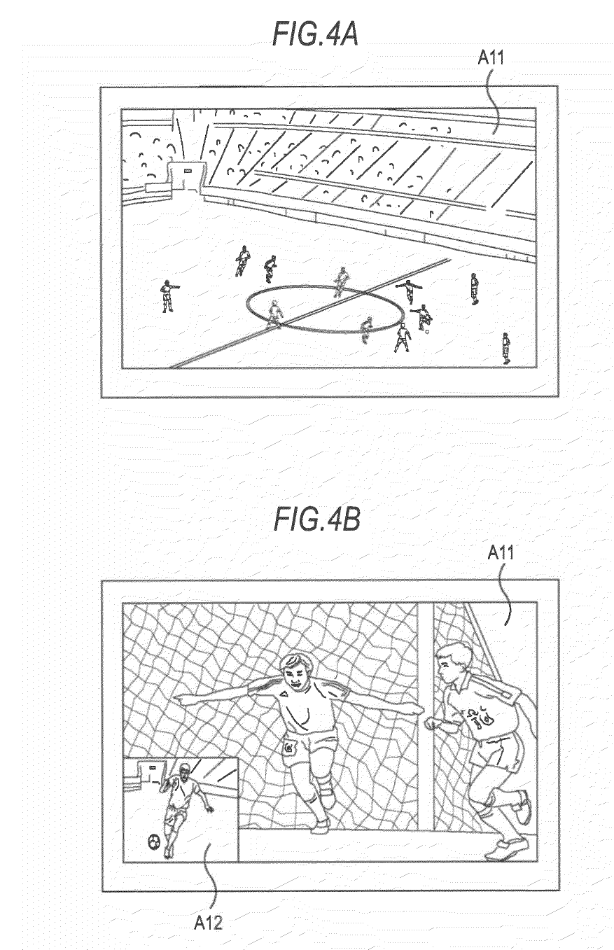

FIGS. 4A and 4B are views showing other examples of display of the TV 2. Detection of an important section is performed at a predetermined timing in the same manner as described with reference to FIG. 2.

FIG. 4A is a view showing an example of display of the TV 2 when the current reproduction position of the content is a position outside an important section. As shown in FIG. 4A, when the reproduction position is a position outside an important section, an image of a soccer broadcast is displayed in a main screen area A11, which is formed on the approximately entire screen, as a 2D image.

FIG. 4B is a view showing an example of display of the TV 2 when the current reproduction position of the content is a position of an important section. When the current reproduction position of the content becomes a position of an important section, an image of the soccer broadcast is displayed in the main screen area A11 as a 3D image. In addition, a multi-screen area A12 is formed in a part of the main screen area A11 so as to overlap it, and a representative image of a scene immediately before the starting position of the important section is displayed in the multi-screen area A12 as a 2D image.

Thus, an image of an important section can be more effectively expressed by displaying an image of the important section of the program in the main screen area A11 as a 3D image and displaying a representative image of another scene as a 2D image with a multi-screen. The user can recognize images in a state where the difference of image display methods is more emphasized.

### [Configuration of the Display Controller 1]

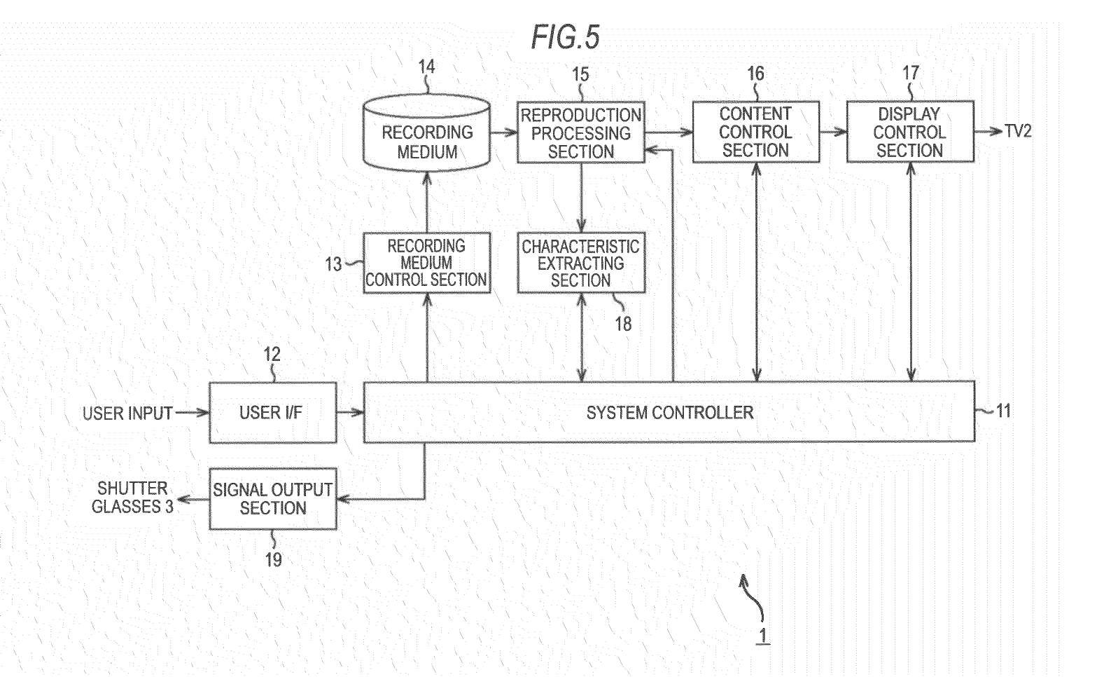

FIG. 5 is a block diagram showing an example of the configuration of the display controller 1.

A system controller 11 controls the overall operation of the display controller 1 according to a signal indicating the content of a user operation supplied from a user I/F 12.

For example, the system controller 11 detects an important section of the content on the basis of the characteristic data supplied from a characteristic extracting section 18. The system controller 11 controls each section on the basis of the detection result such that an image of a program in the important section or a representative image of a scene is displayed as a 3D image and an image of a program outside the important section or a representative image of a scene is displayed as a 2D image.

The user I/F 12 is formed by a light receiving section which receives a signal from a remote controller. The user I/F 12 detects a user operation on a remote controller and outputs a signal indicating the content to the system controller 11.

A recording medium control section 13 controls the recording of the content onto a recording medium 14 or the reading of the content from the recording medium 14. The recording medium 14 is an HDD (Hard Disk Drive) and records the content.

In addition, the recording medium control section 13 receives the broadcast content on the basis of a signal from an antenna (not shown) and records it on the recording medium 14. When the predetermined content is selected from the content recorded on the recording medium 14 by the user and reproduction of the selected content is instructed, the recording medium control section 13 supplies the content, reproduction of which has been instructed, from the recording medium 14 to a reproduction processing section 15.

The reproduction processing section 15 performs reproduction processing, such as decoding processing for decompressing the compressed data, on the content to be reproduced, which have been supplied from the recording medium 14. The reproduction processing section 15 outputs to the characteristic extracting section 18 the image data and the sound data obtained by the reproduction processing, and outputs to a content control section 16 the image data used to display an image of the content. The sound data, which is used to output a sound in accordance with an image of the content, is output from the reproduction processing section 15 to an external speaker or the like through a circuit (not shown).

The content control section 16 outputs the data of a 2D image, which is supplied from the reproduction processing section 15, to a display control section 17 as it is or after converting it into the data of a 3D image.

The display control section 17 displays a screen, which was described with reference to FIGS. 1, 3, 4A, and 4B, on the TV 2 on the basis of the image data supplied from the content control section 16. Specifically, regarding a portion of the entire screen of the TV 2 where a 3D image is displayed, the display control section 17 displays the portion using the image data for a left eye and the image data for a right eye supplied from the content control section 16. In addition, regarding a portion where a 2D image is displayed, the display control section 17 displays the portion using the data of a 2D image supplied from the content control section 16.

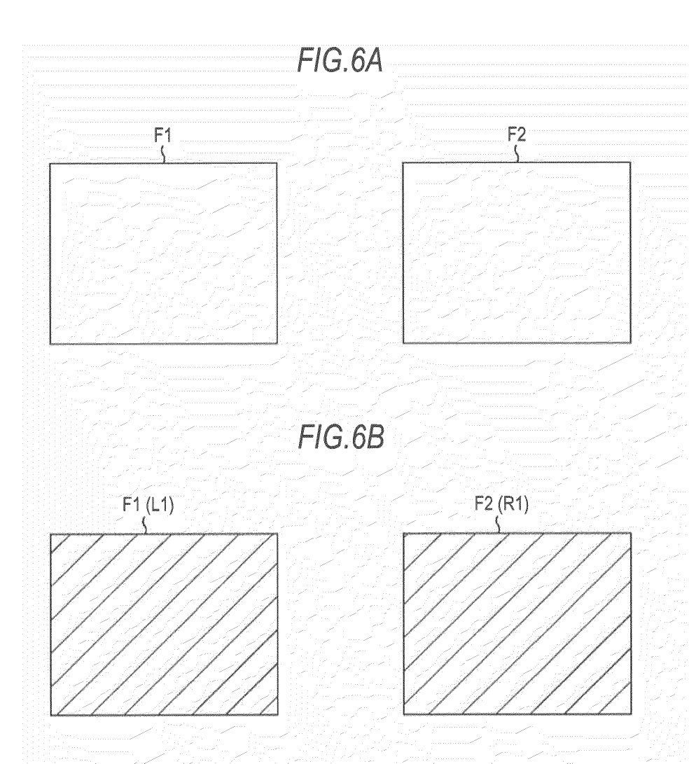

FIGS. 6A and 6B are views showing a portion with parallax in a frame when switching the display method of the entire TV 2 between a 2D display method and a 3D display method as described above with reference to FIG. 1.

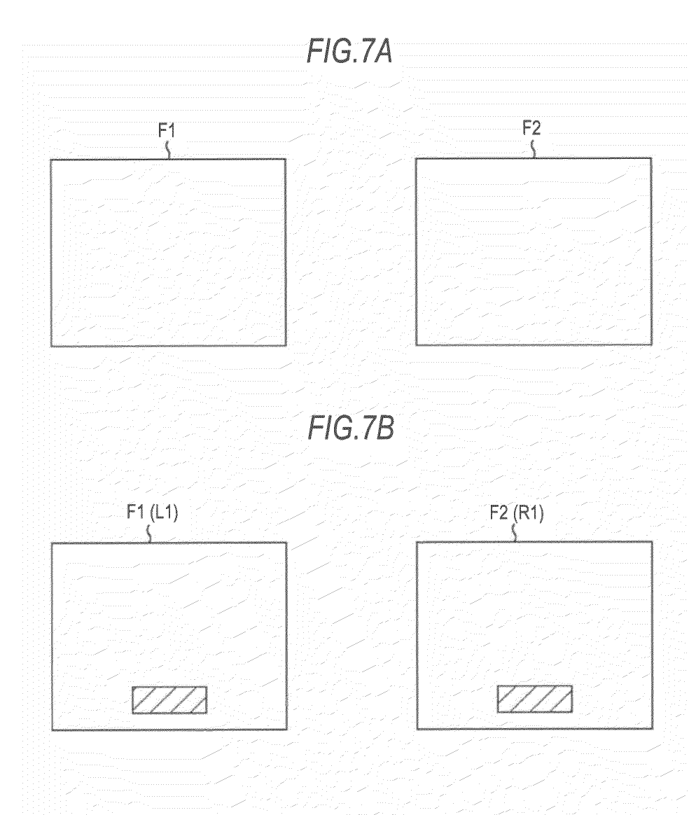

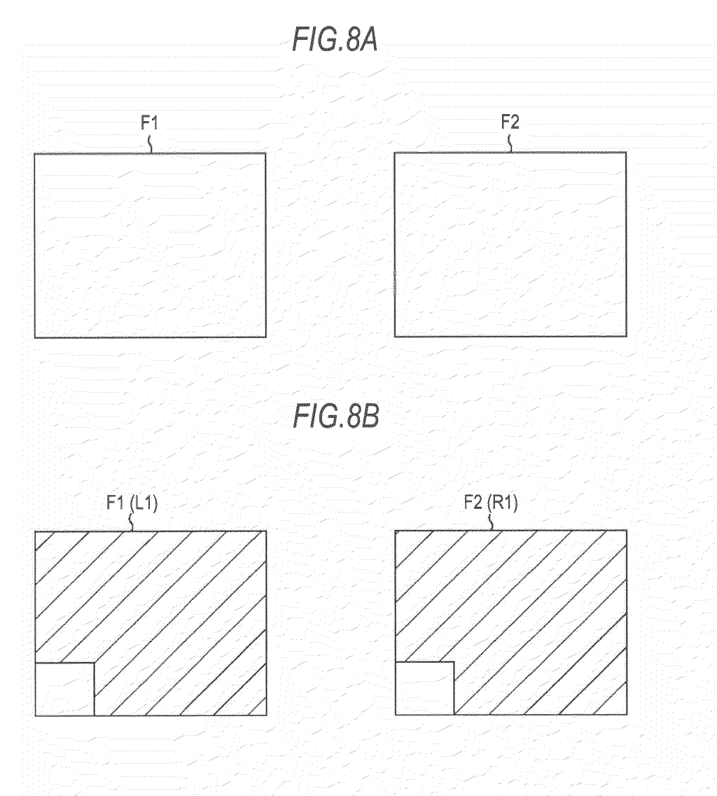

In FIGS. 6A and 6B, actual display content (subject) is not shown, and oblique lines are given to a portion with parallax between frames which continue in display order. The same is true for FIGS. 7A to 8B which will be described later.

Frames F1 and F2 shown in FIG. 6A are frames outside an important section, and are displayed in order of the frames F1 and F2.

The display control section 17 generates the data of each of the frames F1 and F2 on the basis of the data of the 2D image supplied from the content control section 16 and outputs the data to the TV 2. The user watches the image outside the important section of the program, which is displayed on the TV 2, as a 2D image.

Frames F1 and F2 shown in FIG. 6B are frames of an important section, and are displayed in order of the frames F1 and F2. Giving oblique lines to the entire frames F1 and F2 means that there is parallax in the entire frames F1 and F2.

The display control section 17 generates the data of the frame F1 on the basis of the data of an image for a left eye supplied from the content control section 16 and generates the data of the frame F2 on the basis of the data of an image for a right eye supplied from the content control section 16. The display control section 17 outputs to the TV 2 the frame F1 as an image for a left eye (L1 image) and the frame F2 as an image for a right eye (R1 image) which forms a pair together with the frame F1. Since the shutter glasses 3 are also controlled as will be described later, the user watches the image of the important section of the program, which is displayed on the TV 2, as a 3D image.

FIGS. 7A and 7B are views showing a portion with parallax in a frame when representative images of respective scenes are displayed side by side as described with reference to FIG. 3. In this example, the image of the soccer broadcast displayed in the main screen area A1 in FIG. 3 is displayed as a 2D image.

Frames F1 and F2 shown in FIG. 7A are frames when there is no representative image of a scene of an important section among representative images displayed side by side, and are displayed in order of the frames F1 and F2.

The display control section 17 generates the data of each of the frames F1 and F2 (data of a frame in which an image of a program and a representative image are displayed) on the basis of the data of the 2D image supplied from the content control section 16 and outputs the data to the TV 2. The user watches both the image of the program, which is displayed in the main screen area A1 (FIG. 3) of the TV 2, and all representative images, which are displayed side by side in the time-series representative image area A2, as 2D images.

Frames F1 and F2 shown in FIG. 7B are frames when there is a representative image of a scene of an important section among representative images displayed side by side, and are displayed in order of the frames F1 and F2. In each of the frames F1 and F2, a portion to which oblique lines are given is equivalent to the portion where the representative image of the scene of the important section is displayed.

The display control section 17 generates a portion of the frame F1, to which oblique lines are given, on the basis of the data of the image for a left eye supplied from the content control section 16, and generates the other portions on the basis of the data of the 2D image supplied from the content control section 16. In addition, the display control section 17 generates a portion of the frame F2, to which oblique lines are given, on the basis of the data of the image for a right eye supplied from the content control section 16, and generates the other portions on the basis of the data of the 2D image supplied from the content control section 16.

The display control section 17 outputs to the TV 2 the frame F1 as an image for a left eye and the frame F2 as an image for a right eye which forms a pair with the frame F1.

Since the shutter glasses 3 are also controlled, the user watches a representative image, which is displayed in the oblique line portion in FIG. 7B, as a 3D image. In addition, the user watches both the image of the program, which is displayed in the main screen area A1 of the TV 2, and a representative image, which is displayed in the time-series representative image area A2 and is also displayed in a portion other than the oblique line portion in FIG. 7B, as 2D images.

FIGS. 8A and 8B are views showing a portion with parallax in a frame in the case of displaying an image of a program as a 3D image and displaying a representative image of a scene immediately before an important section as a 2D image when the reproduction position becomes the important section as described with reference to FIGS. 4A and 4B.

Frames F1 and F2 shown in FIG. 8A are frames outside an important section, and are displayed in order of the frames F1 and F2.

The display control section 17 generates the data of each of the frames F1 and F2 on the basis of the data of the 2D image supplied from the content control section 16 and outputs the data to the TV 2. The user watches an image outside the important section of the program, which is displayed in the main screen area A11 (FIGS. 4A and 4B) of the TV 2, as a 2D image.

Frames F1 and F2 shown in FIG. 8B are frames of an important section, and are displayed in order of the frames F1 and F2. A portion of each of the frames F1 and F2 to which oblique lines are given is a portion corresponding to the main screen area A11, and a portion to which oblique lines are not given is a portion corresponding to the multi-screen area A12. There is parallax in a portion of the main screen area A11 shown with oblique lines in each of the frames F1 and F2.

The display control section 17 generates a portion of the frame F1, to which oblique lines are given, on the basis of the data of the image for a left eye supplied from the content control section 16, and generates the other portions on the basis of the data of the 2D image supplied from the content control section 16. In addition, the display control section 17 generates a portion of the frame F2, to which oblique lines are given, on the basis of the data of the image for a right eye supplied from the content control section 16, and generates the other portions on the basis of the data of the 2D image supplied from the content control section 16.

The display control section 17 outputs to the TV 2 the frame F1 as an image for a left eye and the frame F2 as an image for a right eye which forms a pair with the frame F1.

Since the shutter glasses 3 are also controlled, the user watches an image of a program, which is displayed in the oblique line portion in FIG. 8B, as a 3D image. In addition, the user watches a representative image, which is displayed in the multi-screen area A12 of the TV 2, as a 2D image.

The display control section 17 generates the data of each frame as described above according to control of the system controller 11 and outputs the data to the TV 2. From the content control section 16, the data of a 2D image or a 3D image used when the display control section 17 generates the data of each frame as described above is supplied.

Referring back to FIG. 5, the characteristic extracting section 18 extracts the characteristics of the image data and the sound data supplied from the reproduction processing section 15 and outputs the characteristic data, which is data indicating the extracted characteristics, to the system controller 11.

A signal output section 19 transmits to the shutter glasses 3 a control signal supplied from the system controller 11. When displaying a 3D image on the TV 2, a control signal for operating the shutter of the shutter glasses 3 is supplied from the system controller 11 at a display timing of each of the image for a left eye and the image for a right eye. Moreover, when displaying only a 2D image on the TV 2, a control signal for making the characteristics (shutter operations) of the light transmissive section on the left eye side and the light transmissive section on the right eye side of the shutter glasses 3 equal is supplied.

In the shutter glasses 3 which receives the control signal transmitted from the signal output section 19, the shutter operations of the light transmissive section on the left eye side and the light transmissive section on the right eye side are controlled, or control for making the characteristics equal is performed. When the characteristics of the light transmissive section on the left eye side and the light transmissive section on the right eye side become the same, the image displayed on the TV 2 is recognized as a normal 2D image by the user.

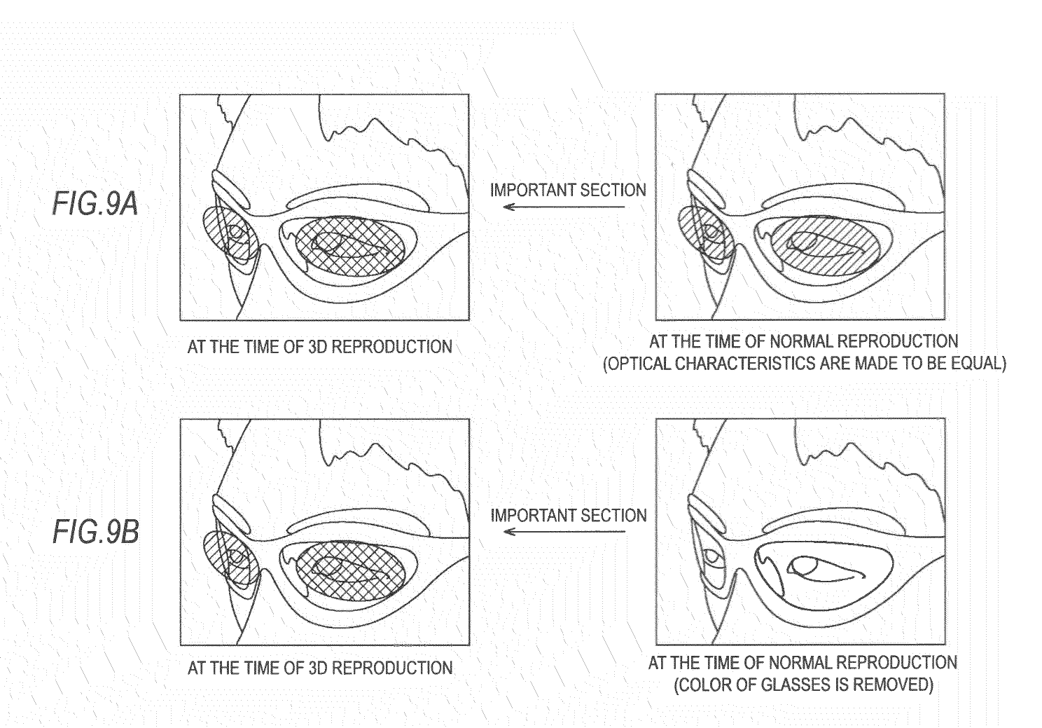

FIGS. 9A and 9B are views showing an example of control of the shutter glasses 3.

When the reproduction position of the content becomes a timing at which a 3D image is displayed due to reaching a position of an important section or the like, the shutter operations of the light transmissive sections on the left and right sides are controlled according to the control signal so that an image for a left eye reaches a left eye and an image for a right eye reaches a right eye, as shown in FIG. 9A.

The right image in FIG. 9A shows a state of the shutter glasses 3 when the characteristics of the light transmissive sections on the left and right sides of the shutter glasses 3 are the same (open timing and close timing are the same). In addition, the left image in FIG. 9A shows a state of the shutter glasses 3 when the characteristics of the light transmissive sections on the left and right sides of the shutter glasses 3 are different (open timing and close timing are different).

In addition, 3D display may also be realized in the color filter method of making the user view images with changed colors as an image for a left eye and an image for a right eye. In this case, it is possible to use glasses capable of controlling the color of each light transmissive section, like red for the light transmissive section on the left eye side and blue for the light transmissive section on the right eye side.

The right image in FIG. 9B shows a state of glasses when the characteristics of light transmissive sections on the left and right sides are the same (in the case of the same color). In addition, the left image in FIG. 9B shows a state of glasses when the characteristics of the light transmissive section on the left eye side and the light transmissive section on the right eye side are different (colors are different). When the reproduction position becomes a position of an important section, the characteristics of the glasses are changed to the state shown at the left side in FIG. 9B. As a result, the user can see a 3D image.

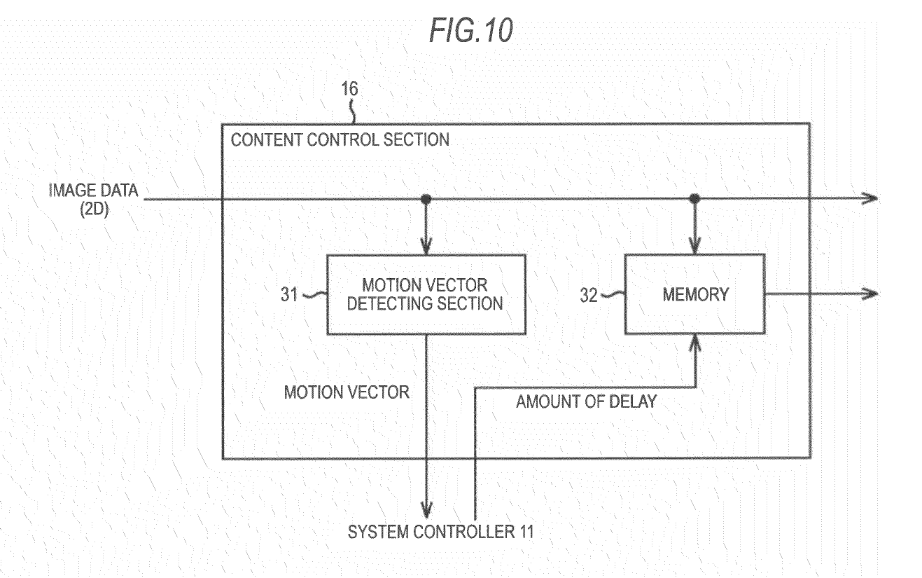

FIG. 10 is a block diagram showing an example of the configuration of the content control section 16 in FIG. 5.

The content control section 16 appropriately converts the data of a 2D image, which is supplied from the reproduction processing section 15, into the data of a 3D image. Converting the data of a 2D image into the data of a 3D image is disclosed in JP-A-7-222203, for example. The configuration shown in FIG. 10 is basically the same configuration as that disclosed in JP-A-7-222203.

As shown in FIG. 10, the content control section 16 includes a motion vector detecting section 31 and a memory 32. The data of a 2D image output from the reproduction processing section 15 is input to the motion vector detecting section 31 and the memory 32 and is also output to the display control section 17 as it is. The data of a 2D image output as it is from the content control section 16 is used in the display control section 17 when displaying a 2D image. Moreover, when displaying a 3D image, it is used as data of an image for a left eye.

The motion vector detecting section 31 detects a motion vector, which indicates a motion of a subject between frames, on the basis of the input image data, and outputs it to the system controller 11. In the system controller 11, the amount of delay of the memory 32 is controlled according to the size of, for example, a horizontal component of the motion vector detected by the motion vector detecting section 31.

When displaying a 3D image, the memory 32 temporarily stores the input image data, delays the image data by the amount of delay supplied from the system controller 11, and outputs the data. The image data output from the memory 32 is used as data of an image for a right eye when displaying a 3D image. The user, who watches the image for a left eye and the image for a right eye output as a 3D image from the content control section 16 with such a configuration, feels a subject stereoscopically by the time difference between the left and right images. The Mach-Dvorak phenomenon is known as a phenomenon similar to feeling a subject stereoscopically by the time difference between left and right images.

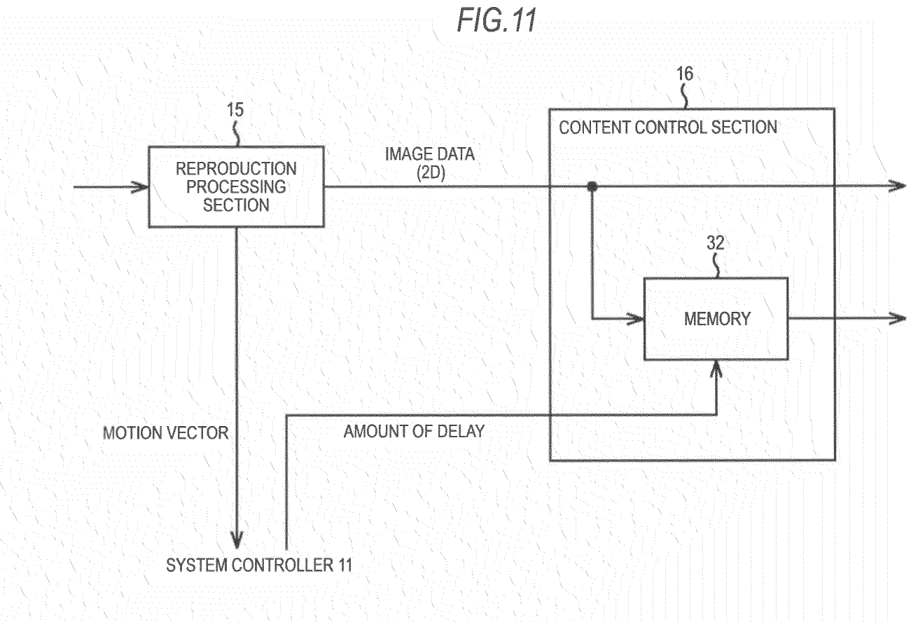

FIG. 11 is a block diagram showing another example of the configuration of the content control section 16.

In this example, a constituent component for detecting a motion vector is not provided in the content control section 16, and the information on a motion vector as a reference for controlling the amount of delay of the memory 32 is supplied from the reproduction processing section 15 to the system controller 11. When the compression method of image data input to the reproduction processing section 15 is an MPEG (Moving Picture Experts Group) 2 or H.264/AVC, for example, the information on a motion vector is included in the image data.

The reproduction processing section 15 outputs the information on the motion vector included in the input image data to the system controller 11 and outputs the data of a 2D image, which is obtained by performing reproduction processing, to the content control section 16. In the system controller 11, the amount of delay is determined on the basis of the motion vector, and the information indicating the determined amount of delay is supplied to the memory 32.

The data of a 2D image output from the reproduction processing section 15 is input to the memory 32 and is also output to the display control section 17 as it is. The data of a 2D image output as it is from the content control section is used when displaying a 2D image. Moreover, when displaying a 3D image, it is used as data of an image for a left eye.

When displaying a 3D image, the memory 32 temporarily stores the input image data, delays the image data by the amount of delay supplied from the system controller 11, and outputs the data. The image data output from the memory 32 is used, for example, as data of an image for a right eye when displaying a 3D image.

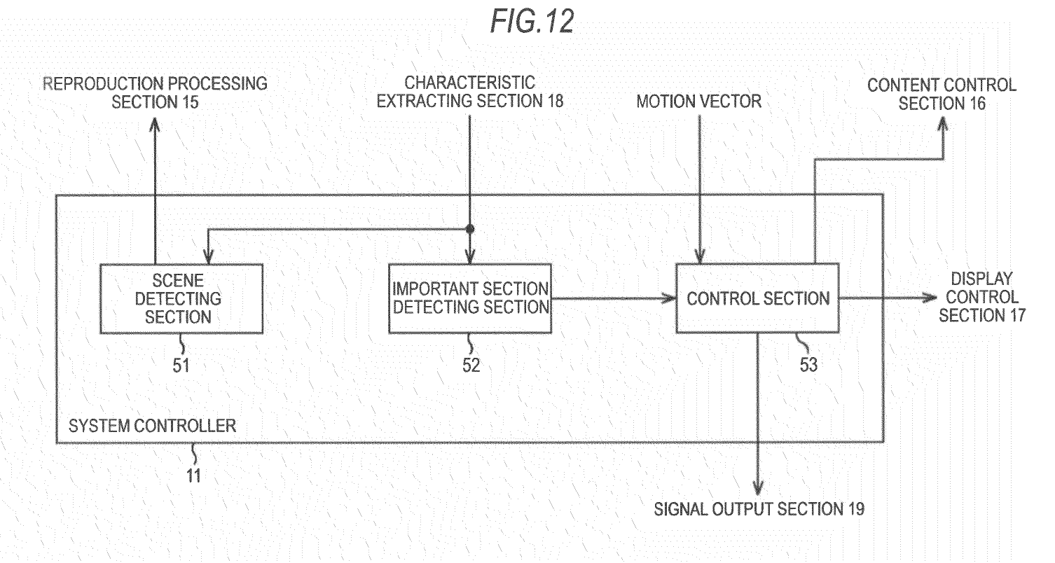

FIG. 12 is a block diagram showing an example of the configuration of the system controller 11 in FIG. 5.

As shown in FIG. 12, the system controller 11 includes a scene detecting section 51, an important section detecting section 52, and a control section 53.

The characteristic data output from the characteristic extracting section 18 is input to the scene detecting section 51 and the important section detecting section 52. In addition, the information on the motion vector, which is output from the motion vector detecting section 31 in FIG. 10 or from the reproduction processing section 15 in FIG. 11, is input to the control section 53.

The scene detecting section 51 detects a scene change on the basis of the characteristics of image data and outputs the information indicating the position to the reproduction processing section 15. The position of the scene change detected by the scene detecting section 51 is used to generate a representative image of each scene in FIG. 3, for example. The reproduction processing section 15 generates a representative image by decoding a frame, which is located immediately after the scene change detected by the scene detecting section 51, and reducing it, for example.

The important section detecting section 52 calculates the evaluation value on the basis of the characteristics of the image data or the sound data as described with reference to FIG. 2, and detects an important section. The important section detecting section 52 outputs the information indicating the important section to the control section 53.

The control section 53 monitors the current reproduction position of the content when displaying an image of the content as a 3D image as described with reference to FIG. 1 or 4. When the current reproduction position becomes a position of the important section, the control section 53 outputs the information on the amount of delay corresponding to the input motion vector to the memory 32 of the content control section 16. For example, the amount of delay T0 is matched with the size V0 of a horizontal component of a motion vector as a reference. When the size of the horizontal component of the input motion vector is V1 which is larger than V0, the control section 53 selects T1, which is smaller than T0, as the amount of delay and outputs the information to the memory 32. In addition, when the size of the horizontal component of the input motion vector is V2 which is smaller than V0, the control section 53 selects T2, which is larger than T0, as the amount of delay and outputs the information to the memory 32. The control section 53 controls the display control section 17 to generate the data of a frame, which was described with reference to FIGS. 6A and 6B or FIGS. 8A and 8B, on the basis of the data supplied from the content control section 16, and output the data.

When displaying a representative image as a 3D image as described with reference to FIG. 3, the control section 53 monitors whether or not the representative image input to the content control section 16 is a representative image of a scene of the important section. When displaying a representative image, representative images generated by the reproduction processing section 15 are sequentially input to the content control section 16.

When the representative image of the scene of the important section is input to the content control section 16, the control section 53 outputs the information on the predetermined amount of delay to the memory 32 of the content control section 16. In addition, the control section 53 controls the display control section 17 to generate the data of a frame, which was described with reference to FIGS. 7A and 7B, on the basis of the data supplied from the content control section 16, and output the data.

In addition, the control section 53 controls reproduction and display of the content and also controls the characteristics of the shutter glasses 3 by outputting a control signal to the signal output section 19.

In the above description, the case has been explained in which one image is used as an image for a left eye and an image obtained by delaying the one image is used as an image for a right eye when generating a 3D image on the basis of a 2D image. However, it is also possible to use one image as an image for a left eye and to use an image, which is obtained by shifting the position of a subject reflected on the image, as an image for a right eye.

### [Operation of the Display Controller 1]

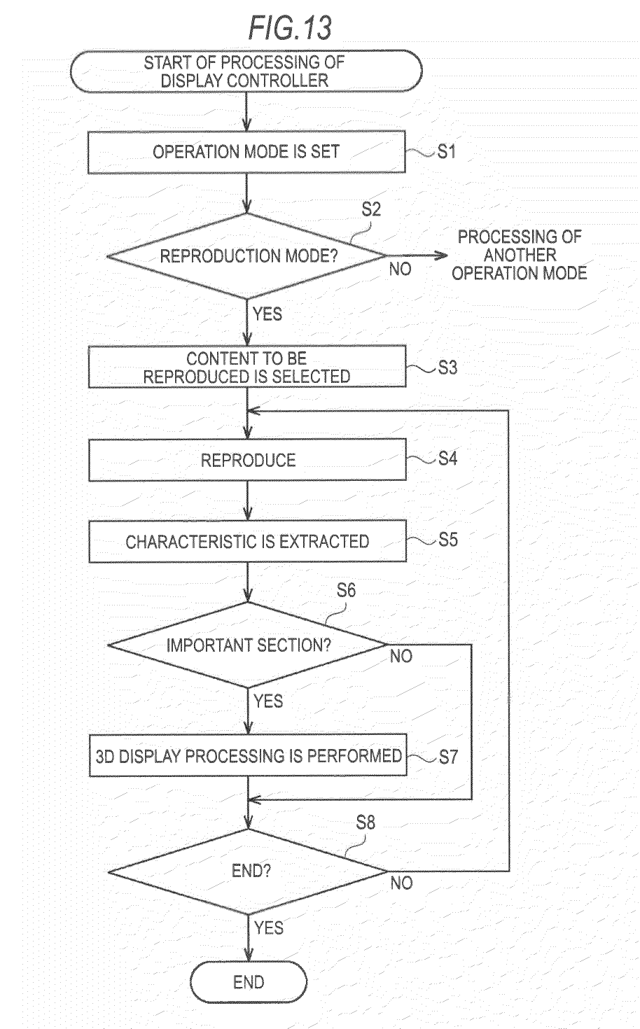

Processing of the display controller 1 will be described with reference to a flow chart shown in FIG. 13.

Here, the process of switching the display method of the entire image of the content from a 2D display method to a 3D display method when the reproduction position becomes a position of an important section as described with reference to FIG. 1 will be described.

In step S1, the system controller 11 sets an operation mode in response to a user's operation. For example, the system controller 11 sets a reproduction mode as an operation mode when reproduction of the content recorded on the recording medium 14 is instructed and sets a recording mode as an operation mode when recording of the content being broadcast is instructed.

In step S2, the system controller 11 determines whether or not the set mode is a reproduction mode. If it is determined that the set mode is not a reproduction mode, the system controller 11 performs processing corresponding to the operation mode which is currently set.

On the other hand, if it is determined that the set mode is a reproduction mode in step S2, the system controller 11 controls the recording medium control section 13 to read the content selected by the user in step S3. The content to be reproduced, which has been read by the recording medium control section 13, is supplied to the reproduction processing section 15.

In step S4, the reproduction processing section 15 reproduces the content to be reproduced, and then outputs the image data to the content control section 16 and also outputs the image data and the sound data to the characteristic extracting section 18.

In step S5, the characteristic extracting section 18 extracts the characteristics of the image data and the sound data and outputs the characteristic data to the system controller 11. The important section detecting section 52 of the system controller 11 detects an important section and supplies the information to the control section 53.

In step S6, the control section 53 determines whether or not the current reproduction position is a position of an important section.

If it is determined that the current reproduction position is a position of an important section in step S6, the control section 53 performs 3D display processing in step S7. That is, the process of displaying the image of the content as a 3D image is performed by controlling the content control section 16, the display control section 17, and the like. If it is determined that the current reproduction position is not a position of an important section in step S6, step S7 is skipped.

In step S8, the system controller 11 determines whether to end reproduction of the content. If it is determined that the reproduction is not ended, the process returns to step S4 to perform subsequent processing.

If it is determined that the reproduction of the content is ended in step S8 since ending the reproduction of the content has been instructed by the user or the content has been reproduced to the last, the processing ends.

Also in the case of performing screen display shown in FIGS. 4A and 4B, the same processing as in FIG. 13 is performed except for the point that a process of displaying a representative image of a scene immediately before the starting position of the important section is included in 3D display processing in step S7.

Moreover, also in the case of performing screen display shown in FIG. 3, the same process as in FIG. 13 is basically performed. That is, when it is determined whether or not a representative image to be displayed is a representative image of a scene of an important section in step S6 and it is a representative image of the scene of the important section, a process of displaying the representative image as a 3D image is performed as 3D display processing in step S7.

### Modifications

Although the case where the content to be reproduced was 2D content was described, 3D content in which the data of an image for a left eye and the data of an image for a right eye are prepared beforehand may also be used as an object to be reproduced. In this case, the process of converting the data of a 2D image into the data of a 3D image described with reference to FIGS. 10 and 11 is not performed in the content control section 16.

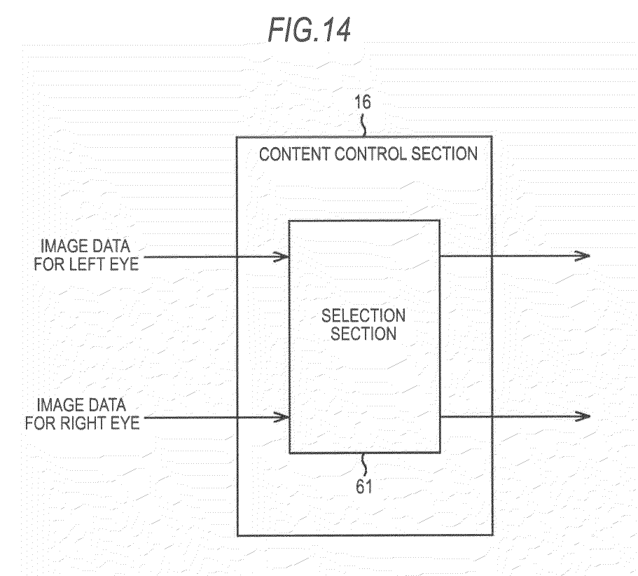

FIG. 14 is a block diagram showing an example of the configuration of the content control section 16 when the content to be reproduced is 3D content.

As shown in FIG. 14, a selection section 61 is provided in the content control section 16. The data of an image for a left eye and the data of an image for a right eye obtained by decoding the 3D content to be reproduced are supplied from the reproduction processing section 15 to the selection section 61. There is a difference equivalent to parallax between the display position of a subject reflected in the image for a left eye and the display position of the subject reflected in the image for a right eye.

According to control of the system controller 11, the selection section 61 outputs the data of the image for a left eye and the data of the image for a right eye to the display control section 17 when displaying a 3D image and outputs, for example, only the data of the image for a left eye to the display control section 17 when displaying a 2D image. The display control section 17 generates the data of each frame on the basis of the image data supplied from the selection section 61 in such a manner described with reference to FIGS. 6A to 8B.

Also in this case, only an image of an important section of the entire 3D content can be displayed as a 3D image. Therefore, it becomes possible to alleviate a feeling of fatigue of the user compared with the case where the user watches images of the entire content as 3D images.

In the above description, the display controller 1 is prepared as a separate device from the TV 2 and functions as an output device that changes the image data which is output according to the current reproduction position. However, the display controller 1 may be provided in the TV 2.

In addition, although the display controller 1 changes the image data to be output according to whether or not the current reproduction position is an important section in FIG. 1, switching of the image data may be performed on the TV 2 side.

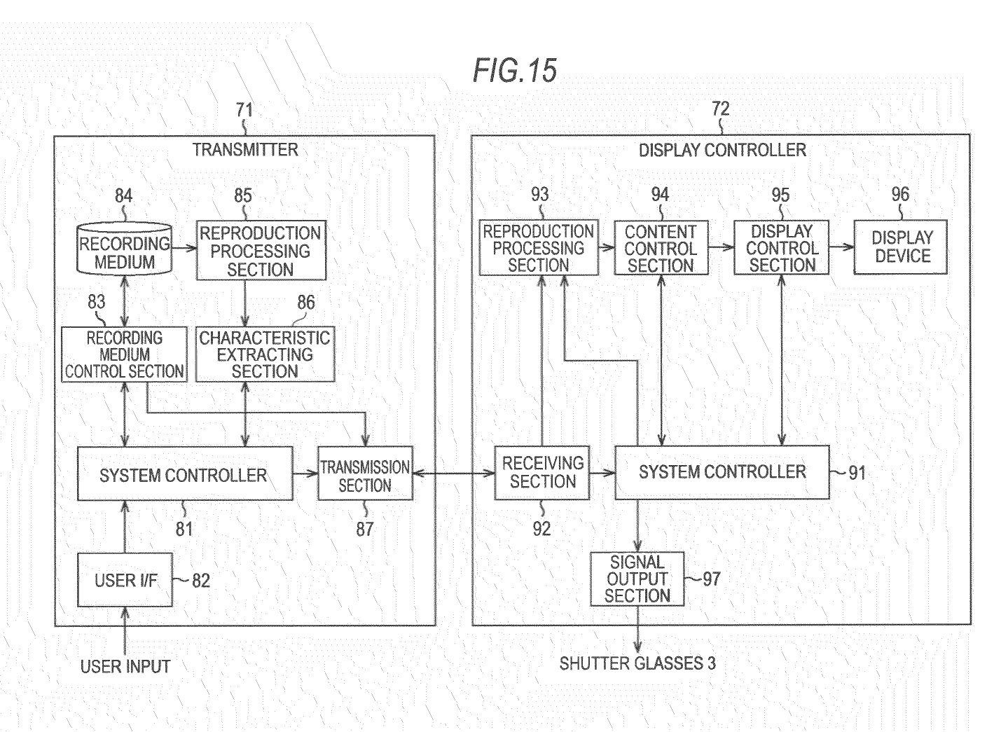

FIG. 15 is a view showing another example of the configuration of a 3D image display system.

The 3D image display system shown in FIG. 15 includes a transmitter 71 and a display controller 72. The display controller 72 is a device provided in the TV 2, for example, and communicates with the transmitter 71, which is provided outside as a separate device from the TV 2, through a cable that meets the HDMI specifications.

In the 3D image display system shown in FIG. 15, the transmitter 71 detects an important section, and the information on the important section is transmitted from the transmitter 71 to the display controller 72 together with the content. The display controller 72 reproduces the content transmitted from the transmitter 71, such that display of an image is switched as described with reference to FIGS. 1, 3, and 4.

As shown in FIG. 15, the transmitter 71 includes a system controller 81, a user I/F 82, a recording medium control section 83, a recording medium 84, a reproduction processing section 85, a characteristic extracting section 86, and a transmission section 87. The user I/F 82, the recording medium control section 83, the recording medium 84, the reproduction processing section 85, and the characteristic extracting section 86 are equivalent to the user I/F 12, the recording medium control section 13, the recording medium 14, the reproduction processing section 15, and the characteristic extracting section 18 shown in FIG. 5, respectively.

The system controller 81 controls the overall operation of the transmitter 71 according to a signal indicating the content of a user operation supplied from the user I/F 82. The scene detecting section 51 and the important section detecting section 52 in the configuration shown in FIG. 12 are provided in the system controller 81 shown in FIG. 15.

For example, the system controller 81 detects a scene change and an important section on the basis of the characteristic data supplied from a characteristic extracting section 86. The system controller 81 outputs to the transmission section 87 the information on the position of the detected scene change and the information on the detected important section.

The user I/F 82 detects a user operation on a remote controller, such as an operation of selecting a program to be reproduced, and outputs a signal indicating the content to the system controller 81.

The recording medium control section 83 receives the broadcast content on the basis of a signal from an antenna (not shown) and records it on the recording medium 84. The recording medium control section 83 outputs content to be reproduced to the reproduction processing section 85 when reproduction of the content recorded on the recording medium 84 is instructed. In addition, the recording medium control section 83 outputs the content to be reproduced to the transmission section 87.

The reproduction processing section 85 performs reproduction processing, such as decoding processing for decompressing the compressed data, on the content to be reproduced. The reproduction processing section 85 outputs the image data and the sound data, which are obtained by performing the reproduction processing, to the characteristic extracting section 86. Either the image data or the sound data may be used as an object from which a characteristic is to be extracted.

The characteristic extracting section 86 extracts the characteristics of the image data and the sound data supplied from the reproduction processing section 85 and outputs the characteristic data, which is data indicating the extracted characteristics, to the system controller 81.

The transmission section 87 transmits the content, which is supplied from the recording medium control section 83, to the display controller 72 through a cable which meets the HDMI specifications. In addition, the transmission section 87 transmits the information on the position of scene change and the information on the important section, which are supplied from the system controller 81, to the display controller 72 in a state where it is stored in an HDMI Vender Specific InfoFrame Packet specified by version 1.4 of HDMI specifications, for example.

The HDMI Vender Specific InfoFrame Packet is a packet used for transmission and reception of a control command specified by each vendor and is transmitted from a device on the transmission side to a device on the reception side through a CEC (Consumer Electronics Control) line of HDMI. Information indicating the position (time) of an important section is included in the information on the important section.

The display controller 72 includes a system controller 91, a receiving section 92, a reproduction processing section 93, a content control section 94, a display control section 95, a display device 96, and a signal output section 97. The reproduction processing section 93, the content control section 94, the display control section 95, and the signal output section 97 are equivalent to the reproduction processing section 15, the content control section 16, the display control section 17, and the signal output section 19 shown in FIG. 5, respectively.

The system controller 91 controls the overall operation of the display controller 72 and reproduces content transmitted from the transmitter 71. The control section 53 in the configuration shown in FIG. 12 is provided in the system controller 91 shown in FIG. 15.

The system controller 91 monitors the current reproduction position of the content when displaying an image of the content as a 3D image as described with reference to FIG. 1 or 4. The system controller 91 outputs the information on the amount of delay to the content control section 94 when the current reproduction position becomes a position of an important section. In addition, the system controller 91 controls the display control section 95 to generate the data of a frame, which was described with reference to FIGS. 6A and 6B or FIGS. 8A and 8B, on the basis of the data supplied from the content control section 94, and output the data.

When displaying a representative image as a 3D image as described with reference to FIG. 3, the system controller 91 monitors whether or not the representative image input to the content control section 94 is a representative image of a scene of the important section. When displaying a representative image, representative images generated by the reproduction processing section 93 are sequentially input to the content control section 94.

When the representative image of the scene of the important section is input to the content control section 94, the system controller 91 outputs the information on the predetermined amount of delay to the content control section 94. In addition, the system controller 91 controls the display control section 95 to generate the data of a frame, which was described with reference to FIGS. 7A and 7B, on the basis of the data supplied from the content control section 16, and output the data.

The receiving section 92 receives the content, the information on the position of scene change, and the information on the important section, which have been transmitted from the transmitter 71, and outputs the content to the reproduction processing section 93 and outputs the information on the position of scene change and the information on the important section to the system controller 91.

The reproduction processing section 93 performs reproduction processing, such as decoding processing for decompressing the compressed data, on the content supplied from the receiving section 92. The reproduction processing section 93 outputs the data of a 2D image, which is obtained by performing the reproduction processing, to the content control section 94. The sound data, which is used to output a sound in accordance with the image of the content, is output to an external speaker or the like through a circuit (not shown). The reproduction processing section 93 appropriately generates a representative image according to control of the system controller 91 and outputs the generated representative image to the content control section 94.

The content control section 94 has the same configuration as shown in FIG. 10 or 11. The content control section 94 outputs the data of a 2D image, which is supplied from the reproduction processing section 93, to the display control section 95 as it is or after converting it into the data of a 3D image.

The display control section 95 displays a screen, which was described with reference to FIGS. 1, 3, and 4, on the display device 96 on the basis of the image data supplied from the content control section 94.

The signal output section 97 transmits a control signal to control the shutter operation of the shutter glasses 3 as described with reference to FIGS. 9A and 9B.

Also in the 3D image display system with such a configuration, it is possible to display the screen described with reference to FIGS. 1, 3, and 4.

Moreover, although the method using glasses is set as a watching method of a 3D image in the above description, a naked-eye method may also be applied. Also in the naked-eye method, display of an image is controlled so that a user can see a 3D image in an important section, and display of an image is controlled so that the user can see a 2D image in a normal section.

The series of processes described above may be executed by hardware or may be executed by software. In the case of executing a series of processes using software, a program included in the software is installed from a program recording medium into a computer provided in dedicated hardware or into a general-purpose personal computer.

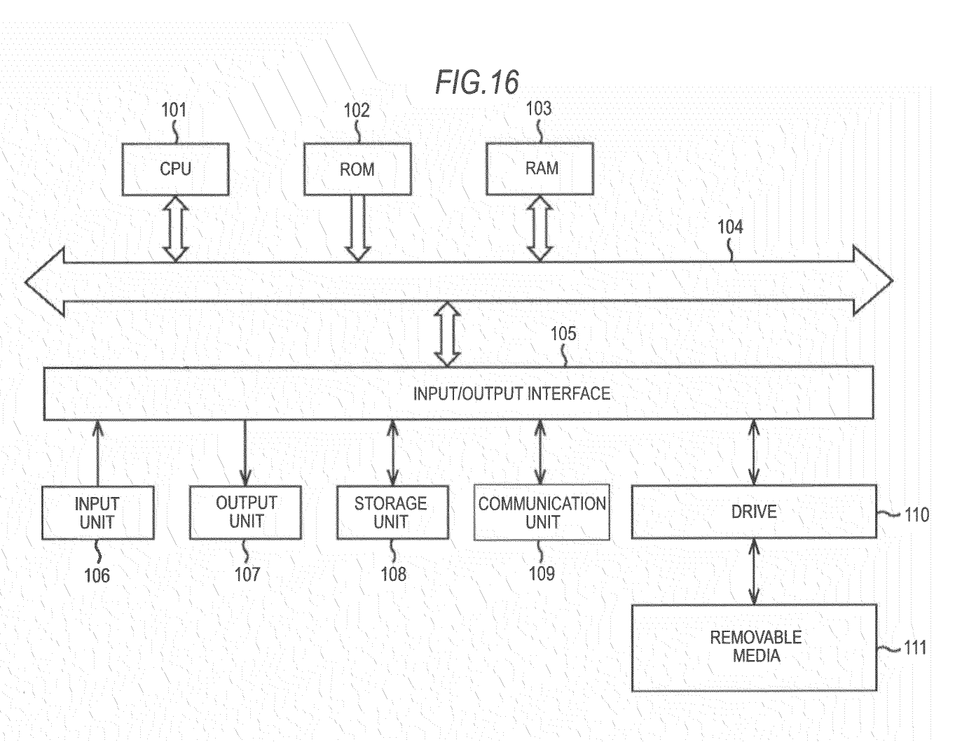

FIG. 16 is a block diagram showing an example of the hardware configuration of a computer which executes the series of processes described above using a program.

A CPU (Central Processing Unit) 101, a ROM (Read Only Memory) 102, and a RAM (Random Access Memory) 103 are connected to each other by a bus 104.

In addition, an input/output interface 105 is connected to the bus 104. An input unit 106 formed by a keyboard, a mouse, and the like and an output unit 107 formed by a display device, a speaker, and the like are connected to the input/output interface 105. In addition, a storage unit 108 formed by a hard disk, a nonvolatile memory, and the like, a communication unit 109 formed by a network interface and the like, and a drive 110 which drives removable media 111 are connected to the input/output interface 105.

In the computer configured as described above, for example, the CPU 101 loads a program stored in the storage unit 108 to the RAM 103 through the input/output interface 105 and the bus 104 and executes it in order to execute the series of processes described above.

For example, the program executed by the CPU 101 is supplied in a state recorded on the removable media 111 or supplied through cable or wireless transmission media, such as a local area network, the Internet, and digital broadcasting, and is installed in the storage unit 108.

In addition, the program executed by a computer may be a program which performs processing in a time-series manner in the order described in this specification, or may be a program which performs processing in parallel or at a necessary timing, such as when a call is performed.

Embodiments of the present invention are not limited to the above-described embodiments, but various modifications may be made without departing from the spirit and scope of the present invention.

The present application contains subject matter related to that disclosed in Japanese Priority Patent Application JP 2009-254957 filed in the Japan Patent Office on Nov. 6, 2009, the entire contents of which is hereby incorporated by reference.

What is claimed is:

1. A display controller comprising:
an extraction means for extracting a characteristic of at least one of image data and sound data of content;
a detection means for detecting a predetermined section of the content for which an evaluation value calculated on the basis of the characteristic extracted by the extraction means is equal to or larger than a threshold value; and
a display control means for controlling display of a representative image of each scene of the content, the display control means displaying a representative image of a scene of the predetermined section so as to be recognized as a three-dimensional image and displaying a representative image of a scene outside the predetermined section so as to be recognized as a two-dimensional image.

2. The display controller according to claim 1, further comprising:
a conversion means for converting the input content into content including image data for a left eye and image data for a right eye with parallax for displaying a three-dimensional image when the content input as an object to be reproduced is content including only image data for displaying a two-dimensional image as image data,
wherein the display control means displays a representative image of a scene of the predetermined section on the basis of the content converted by the conversion means and displays a representative image of a scene outside the predetermined section on the basis of the input content.

3. The display controller according to claim 1,
wherein when the content input as an object to be reproduced is content including image data for a left eye and image data for a right eye with parallax as image data, the display control means displays a representative image of a scene of the predetermined section on the basis of the image data for a left eye and the image data for a right eye included in the input content, and displays a representative image of a scene outside the predetermined section on the basis of either the image data for a left eye or the image data for a right eye.

4. A display control method comprising the steps of:
extracting a characteristic of at least one of image data and sound data of content;
detecting a predetermined section of the content for which an evaluation value calculated on the basis of the extracted characteristic is equal to or larger than a threshold value; and
displaying a representative image of a scene of the predetermined section so as to be recognized as a three-dimensional image and displaying a representative image of a scene outside the predetermined section so as to be recognized as a two-dimensional image when displaying a representative image of each scene of the content.

5. A program causing a computer to execute processing including the steps of:
extracting a characteristic of at least one of image data and sound data of content;
detecting a predetermined section of the content for which an evaluation value calculated on the basis of the extracted characteristic is equal to or larger than a threshold value; and
displaying a representative image of a scene of the predetermined section so as to be recognized as a three-dimensional image and displaying a representative image of a scene outside the predetermined section so as to be recognized as a two-dimensional image when displaying a representative image of each scene of the content.

6. An output device comprising:
an extraction means for extracting a characteristic of at least one of image data and sound data of content;
a detection means for detecting a predetermined section of the content for which an evaluation value calculated on the basis of the characteristic extracted by the extraction means is equal to or larger than a threshold value; and
an output means for outputting a representative image of each scene of the content, the output means outputting a representative image of a scene of the predetermined section as a three-dimensional image and outputting a representative image of a scene outside the predetermined section as a two-dimensional image.

7. A transmitter comprising:
an extraction means for extracting a characteristic of at least one of image data and sound data of content;
a detection means for detecting a predetermined section of the content for which an evaluation value calculated on the basis of the characteristic extracted by the extraction means is equal to or larger than a threshold value; and
a transmission means for transmitting data regarding the detected predetermined section together with the image data of the content.

8. A display controller comprising:
a receiving means for receiving data of content including at least image data and also receiving data regarding a predetermined section of the content for which an evaluation value calculated on the basis of a characteristic of at least one of image data and sound data of the content is equal to or larger than a threshold value; and
a display control means for controlling display of a representative image of each scene of the content, the display control means displaying a representative image of a scene of the predetermined section so as to be recognized as a three-dimensional image and displaying a representative image of a scene outside the predetermined section so as to be recognized as a two-dimensional image.

9. A display controller comprising:
an extraction unit configured to extract a characteristic of at least one of image data and sound data of content;
a detection unit configured to detect a predetermined section of the content for which an evaluation value calculated on the basis of the characteristic extracted by the extraction unit is equal to or larger than a threshold value; and
a display control unit configured to control display of a representative image of each scene of the content, the display control unit displaying a representative image of a scene of the predetermined section so as to be recognized as a three-dimensional image and displaying a representative image of a scene outside the predetermined section so as to be recognized as a two-dimensional image.

10. An output device comprising:
an extraction unit configured to extract a characteristic of at least one of image data and sound data of content;
a detection unit configured to detect a predetermined section of the content for which an evaluation value calculated on the basis of the characteristic extracted by the extraction unit is equal to or larger than a threshold value; and
an output unit configured to output a representative image of each scene of the content, the output unit outputting a representative image of a scene of the predetermined section as a three-dimensional image and outputting a representative image of a scene outside the predetermined section as a two-dimensional image.

11. A transmitter comprising:
an extraction unit configured to extract a characteristic of at least one of image data and sound data of content;
a detection unit configured to detect a predetermined section of the content for which an evaluation value calculated on the basis of the characteristic extracted by the extraction unit is equal to or larger than a threshold value; and
a transmission unit configured to transmit data regarding the detected predetermined section together with the image data of the content.

12. A display controller comprising:
a receiving unit configured to receive data of content including at least image data and also receive data regarding a predetermined section of the content for which an evaluation value calculated on the basis of a characteristic of at least one of image data and sound data of the content is equal to or larger than a threshold value; and
a display control unit configured to control display of a representative image of each scene of the content, the display control unit displaying a representative image of a scene of the predetermined section so as to be recognized as a three-dimensional image and displaying a representative image of a scene outside the predetermined section so as to be recognized as a two-dimensional image.
